(19) United States
(12) Patent Application Publication
(10) Pub. No.: US 2011/0222836 A1
(43) Pub. Date: Sep. 15, 2011

(54) VIDEO EDITING WITH A PC DATA LINKED TO A VIDEO CAPTURE DEVICE

(75) Inventor: Munehiro Nakazato, Sunnyvale, CA (US)

(73) Assignee: SONY CORPORATION, Tokyo (JP)

(21) Appl. No.: 12/723,453

(22) Filed: Mar. 12, 2010

(51) Int. Cl. H04N 5/93; G11B 27/00; H04N 5/917

(52) U.S. Cl. 386/282; 386/E05.003; 386/329

(57) ABSTRACT

A personal computer with a graphical user interface is connected through a data link to an image capture device whereupon one or more images are stored. The image capture device comprises specialized graphical or video hardware, which may be controlled by the graphical user interface through signals passed through the data link. In response to those signals, the image capture device then processes one or more selected images or groups of pictures with the stored images, thereby performing one or more editing functions. By using the specialized hardware and capacious storage typically present on the image capture device, only low capability personal computers are required. Depending on the screen size and hardware capabilities of the image capture device, the personal computer may comprise a sufficient screen sized netbook, laptop, desktop computer, smart phone, MP3 player, or other personal digital assistant (PDA).

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to image and video editing and more particularly to image and video editing between interconnected image acquisition hardware and a personal computer.

2. Description of Related Art

Traditional personal computers have limited ability to edit even still images. When an image set is a video, personal computers are sorely pressed to provide functional, responsive, video editing.

On the other hand both digital still cameras and video capture devices suffer from user interface limitations; there are only so many buttons and graphics that may be placed in small, hand-held devices. Due to the requirements of fast image collection and compression, more than a few digital still cameras, and nearly all video cameras, contain image processing hardware specialized to these tasks.

### BRIEF SUMMARY OF THE INVENTION

An aspect of the invention is an interconnected image processing system, comprising: an image capture device, comprising one or more stored image; a personal computer, comprising a graphical user interface; wherein the image capture device and the personal computer are interconnected through a data link; and means for editing the stored images on the image capture device by a user that interacts with the graphical user interface.

The image capture device may be selected from a group of image capture devices consisting of: a digital still camera and a video camera.

The means for editing may comprise: one or more instructions sent from the personal computer to the image capture device over the data link; wherein one or more digital edit commands are executed by the image capture device on one or more of the stored images.

The data link may be selected from a group of interconnections consisting of: a Universal Serial Bus (USB) cable, an IEEE 1394 cable, a SATA cable, an eSATA cable, a Bluetooth connection, a fiber optic connection, a wireless 802 connection, and an infrared connection. In general, some of these interconnections may be faster than others, which may contribute to faster data communications between the image capture device and the personal computer. However, since commands and generally small image frames are generally passed through the data link, signal bandwidth requirements are generally fairly low.

The data link may comprise a data bus that interconnects the image capture device to the personal computer, whereby data may flow between them. Among this data may be instructions passed from the personal computer to the image capture device for operations to be performed on the image capture device.

The image capture device may comprise an image processing unit. In the case of a digital still camera, there may only be limited processing available, and only for still images. For video cameras, there may be sophisticated codecs for H.264 coding and decoding realized in hardware or software for high definition video conforming to the H.264 standards and beyond.

The one or more stored images may be selected from a group of stored images consisting of: digital still images, and a group of pictures (GOP). In the marketplace, there is significant overlap of these devices, including digital still cameras that additionally take videos, and video cameras that take still pictures.

The group of pictures (GOP) described above may comprise B pictures, I pictures, P pictures, and combinations of the foregoing pictures as used in various video compression standards, including MP4 and H.264.

The commands may comprise one or more commands consisting of: select, cut, copy, paste, move, delete, and view. Additional commands may cover traditional still and video edit operations.

The means for editing may comprise: decompression, on the image capture device, of at least a portion of the stored images; compression, on the image capture device, of one or more edited images; and output, on the image capture device, of the one or more edited images into one or more of the stored images. Here, the decompression or compression (otherwise termed recompression) may use any of the codecs such as used in various video compression standards, including MP4 and H.264 for video images, and jpeg and other compression methods for still images.

Another aspect of the invention is a method for interconnected image processing, comprising: providing one or more stored images in an image capture device; providing a personal computer, comprising a graphical user interface; providing a data link for connecting the image capture device with the personal computer; and editing the stored images on the image capture device via one or more commands sent from the personal computer via the data link.

Here, the commands are user inputs that originate from a graphical user interface on the personal computer. The user may issue edit commands to the image capture device to edit one or more of the stored images.

The edit commands may be selected from one or more commands of a group of commands consisting of: select, cut, copy, paste, move, delete, and view. Addition commands may be provided to cover traditional still and video image processing functions, including but not limited to overlay, join, move, swap, blend, fade, etc.

A computer may be capable of performing the method for interconnected image processing described above.

A computer program executable, stored on a computer readable medium, may be capable of performing the method for interconnected image processing described above.

The method for interconnected image processing may additionally, comprise: decompressing, on the image capture device, of at least a portion of the stored images; compressing, on the image capture device, of one or more edited images into one or more compressed edited images; and storing, on the image capture device, one or more of the compressed edited images as one or more of the stored images. Here, the decompressing and compressing steps may be selected from codecs selected from the group of codecs consisting of: BMP, TIFF, DPCM, LZW, entropic encoding, GIF, PNG, MNG, RAW, JPEG, MPEG-2, MPEG-4, VC1, and H.264.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a perspective view of an image capture device interconnected with a personal computer.

FIG. 2 is a table comparing the strengths and weaknesses of still and video image editing on a personal computer and an image capture device.

### DETAILED DESCRIPTION OF THE INVENTION

1. Definitions

The following terms are used herein and are thus defined to assist in understanding the description of the invention(s). Those having skill in the art will understand that these terms are not immutably defined and that the terms should be interpreted using not only the following definitions but variations thereof as appropriate within the context of the invention(s).

“Codec” means a device or computer program capable of encoding or decoding a digital data stream or signal. The word codec is a portmanteau of “compressor-decompressor” or, more accurately, “coder-decoder”. Instances of video codec standards include, but are not limited to MPEG-2, MPEG-4, SMPTE (Society of Motion Picture and Television Engineers) 421M video codec (VC1), and H.264, bidirectional prediction (Bi prediction). For still pictures, non-limiting examples of compression/decompression include lossless and lossy encodings. Lossless encodings may be found in run-length encoding, bitmap (BMP), Tagged Image File Format (TIFF), Differential Pulse-Code Modulation (DPCM), related Predictive Coding, Entropic encoding, Adaptive dictionary algorithms such as Lempel-Ziv-Welch (LZW), which are used in the Graphics Interchange Format (GIF) and TIFF, deflation as used in Portable Network Graphics (PNG), Multiple-image Network Graphics (MNG), among others. Additional lossless encoding methods are found in various proprietary methods employed by different manufacturers such as Canon with its RAW format. Methods for lossy compression include transform coding, such as the Fourier-related transforms, wavelet transforms, fractal compressions, and JPEG, among many others.

“Computer” means any device capable of performing the steps, methods, or producing signals as described herein, including but not limited to: a microprocessor, a microcontroller, a video processor, a digital state machine, a field programmable gate array (FGPA), a digital signal processor, a collocated integrated memory system with microprocessor and analog or digital output device, a distributed memory system with microprocessor and analog or digital output device connected by digital or analog signal protocols.

“Computer readable medium” means any source of organized information that may be processed by a computer to perform the steps described herein to result in, store, perform logical operations upon, or transmit, a flow or a signal flow, including but not limited to: random access memory (RAM), read only memory (ROM), a magnetically readable storage system; optically readable storage media such as punch cards or printed matter readable by direct methods or methods of optical character recognition; other optical storage media such as a compact disc (CD), a digital versatile disc (DVD), a rewritable CD and/or DVD; electrically readable media such as programmable read only memories (PROMs), electrically erasable programmable read only memories (EEPROMs), field programmable gate arrays (FGPAs), flash random access memory (flash RAM); and information transmitted by electromagnetic or optical methods including, but not limited to, wireless transmission, copper wires, and optical fibers.

“Data link” means any method of interconnecting two devices to enable bidirectional data communications.

“eSATA” means external serial advanced technology attachment.

“GOP (Group of Pictures)” means P and/or B-frames between successive I-frames in an MPEG signal. A GOP is usually about 15 frames long in an NTSC system. The length of a GOP can vary depending on editing requirements. The length of a GOP represents the editing capability of an MPEG signal. If an edit occurs within a GOP, an MPEG codec will be needed to reclose the GOP. A GOP must begin with an I-frame and end with an I-frame, therefore if a cut occurs in the middle of a GOP, the signal needs to be reconstructed with a codec.

“I, P, B frames” mean the three major picture types found in typical video compression designs. They are I(ntra) (or key) pictures, P(redicted) pictures, and B(i-predictive) pictures (or B(i-directional) pictures). They are also commonly referred to as I frames, P frames, and B frames, respectively. In older reference documents, the term “bi-directional” rather than “bi-predictive” is dominant to describe a B frame.

“Image Processor” means any device capable of performing the steps, methods, or producing signals relating to images as described herein, including but not limited to: a microprocessor, a microcontroller, a video processor, a graphical processing unit (GPI), a digital state machine, a field programmable gate array (FGPA), a digital signal processor, a collocated integrated memory system with processor and analog or digital output device, a distributed memory system with microprocessor and analog or digital output device connected by digital or analog signal protocols.

“Personal computer” means a computer traditionally used by one to a few people, having a processor, memory, and a display. Such personal computers, or “PCs” are exemplified without limitation as a desktop computer, laptops, a netbook computer, and the like, and smart phones, MP3 players, or other personal digital assistants (PDAs) with attached or detachable displays higher than 400×300 pixels. Within the meaning of this patent, even digital book readers would qualify as a “personal computer”.

“SATA” means serial advanced technology attachment.

“Wireless 802 Connection” means any of the standards conforming to section 802.11 of the Institute of Electrical and Electronics Engineers standards on wireless local area networking, including without limitation 802.11b, 802.11g, and 802.11n.

2. Introduction

Image capture devices include digital still cameras, video cameras, and mixed-capability devices that perform some of both still and video capture. Most consumer and many professional image capture devices are handheld.

Handheld image capture devices appear to be near or at the limit of complexity for user operation, with digital still cameras, such as the Canon 20D, having a bewildering array of buttons and knobs, with relatively small display screens on such devices. Thus, it appears unlikely that significant editing of captured images could be accomplished on the device itself.

Similarly, for video capture devices, editing of video streams, other than gross start recording and stop recording, appears unlikely.

Such small screens appear to limit editing capabilities in handheld image capture devices in at least two ways: 1) there is a limit to the number of knobs and buttons that a user may learn and typically use, and 2) the small screen size limits the complexity of any graphical user interface to relatively rudimentary operations, likely beyond that of image or video editing.

Video capture devices may contain sophisticated signal processing hardware and software, allowing for the direct capture of HD video streams or extremely high resolution still images. Such signal processing hardware is traditionally lacking on lower end personal computers.

Even low processing powered Intel Atom N270™ processor-based netbooks have significantly larger display area than is present on the traditional video capture device. Additionally, such netbooks have access to a plethora of user input devices such as keyboards, mice, etc., as do nearly all personal computers. By themselves, such netbooks would never realistically be usable imaging edit stations due to the lack of the signal processing hardware. Therefore, any direct editing capability would be lacking on less powerful personal computers.

However, by linking a lower (or even higher) powered personal computer with a video capture device with sophisticated signal processing hardware, realistic image editing becomes possible on the less powerful personal computers.

Additionally, since the image capture device already has the subject images or video streams stored, there is no need for such storage on the personal computer, which may have only a fraction of the video capture device storage capacity.

High definition video editing is extremely computationally demanding, requiring either extremely powerful processors, specialized signal processing hardware, or both. As previously discussed, video editing on a camcorder or other digital still camera handheld device is less usable than on a personal computer.

Video image size is ever increasing, likely to go beyond present typical levels of 1920×1080 pixels at 60 Hz to even higher resolutions and frame rates. These sizes and refresh rates require massive storage and image processing power, which is already present on the handheld recorder.

3. Editing Process

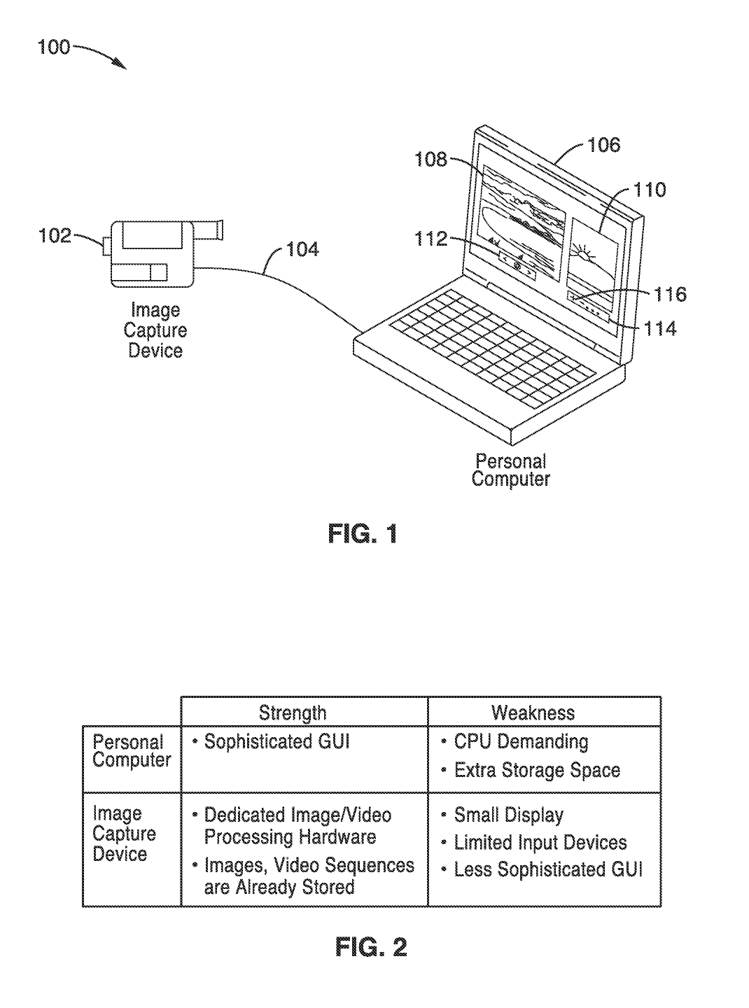

Refer now to FIG. 1, which is a depiction of such a linked editing system 100. Here, an image capture device 102 connects though a data link 104 to a personal computer 106. The data link 104 is indicated here without limitation as a wired connection, and could be wireless, Bluetooth, WiFi, 802 networked, LAN or WAN connected, or connected in still another way permitting communication between the image capturing device 102, e.g. Camcorder or Digital Still Camera (DSC) and the personal computer 106.

The personal computer 106 may have displayed one or more edit viewing screens 108, 110 allowing a user to view image contents on the image capture device 102. A scroll bar 112 may control viewing screen 108 to allow for the viewing of video streams or individual still images stored on the image capture device 102. Similarly, a palette 114 of edit functions 116 may be placed on the personal computer 106 to allow for image editing operations.

These editing functions 116 are selected by a user from the graphical user interface palette 114 on the personal computer 106 to cause edits to occur on the image capture device 102 to the various images (resident on the image capture device 102) depicted in the viewing screens 108, 110. These edits utilize the specialized image processing hardware present on the image capture device 102.

4. Benefits

Refer now to FIG. 2, which is a comparison of the Strengths and Weaknesses between an Image Capture Device and a Personal Computer 200. Also refer to FIG. 1.

Because the user can use the personal computer video editing software on a much more sophisticated graphical user interface, an improved user experience is achieved over using either the image capture device 102, or the personal computer 106 alone. Since the graphical user interface on the personal computer 106 may be much more detailed than that on image capture device 102, editing becomes easier and more functional, with fewer unlabeled or poorly understood buttons or knobs.

Since the personal computer is not directly used for video processing, high definition video editing becomes possible even on less powerful PC such as notebooks and netbooks. Further, since large sized video sequences do not need to be transferred to the personal computer 106, even high definition video editing is possible even with personal computers having very limited disk storage.

Alternatively, a weakness of the personal computer is that it may not be able to realistically process video editing requests, which are CPU demanding, and may have relatively small storage.

With the image capture device 102, specialized hardware processes the edit requests from the personal computer 106 over data link 104. This does not subject the user to a confusing and cramped edit interface on the image capture device 102.

It should be noted current video capture devices store video image sequences in various compressed (encoded) formats rather than simple sequential raw frames. Otherwise, high definition (HD) video sequences would require excessive storage.

Where video image sequences are compressed, the video editing process involves decompression of at least a portion of the video image sequence from the storage on the image capture device before the user can edit the frames. Then, after editing, the edited footage sequence must again be stored again in compressed (encoded) format. The frequent decompression and compression during video editing are very computationally intensive already. In the future, as video codec standards increase in complexity, such editing would be even more difficult in the absence of the specialized hardware present on the video capture device.

The use of the video codec hardware in the capturing devices reduces the demand in PCs significantly.

Further, the image capture device 102 does not typically allow for the wide variety of input devices available to a personal computer 106, such as keyboards, mice, tablets, etc.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart

From the discussion above it will be appreciated that the invention can be embodied in various ways, including the following:

1. An interconnected image processing system, comprising: an image capture device, comprising one or more stored images; a personal computer, comprising a graphical user interface; wherein the image capture device and the personal computer are interconnected through a data link; and means for editing the stored images on the image capture device via one or more commands entered by a user that interacts with the graphical user interface.

2. The system of embodiment 1, wherein the image capture device is selected from a group of image capture devices consisting of: a digital still camera and a video camera.

3. The system of embodiment 1, wherein the means for editing comprises: one or more instructions sent from the personal computer to the image capture device over the data link; wherein one or more digital edit commands are executed by the image capture device on one or more of the stored images.

4. The system of embodiment 3, wherein the data link is selected from a group of interconnections consisting of: a Universal Serial Bus (USB) cable, an IEEE 1394 cable, a SATA cable, an eSATA cable, a Bluetooth connection, a fiber optic connection, a wireless 802 connection, and an infrared connection.

5. The system of embodiment 1, wherein the data link comprises a data bus that interconnects the image capture device to the personal computer, whereby bidirectional data may flow.

6. The system of embodiment 1, wherein the image capture device comprises an image processing unit.

7. The system of embodiment 1, wherein the one or more stored images are selected from a group of stored images consisting of: digital still images, a group of pictures (GOP), and a combination of the foregoing.

8. The system of embodiment 7, wherein the group of pictures (GOP) comprise B pictures, I pictures, P pictures, and combinations of the foregoing pictures.

9. The system of embodiment 1, wherein the commands comprise one or more commands consisting of: select, cut, copy, paste, move, delete, and view.

10. The system of embodiment 1, wherein the means for editing comprises: decompression, on the image capture device, of at least a portion of the stored images; compression, on the image capture device, of one or more edited images; and output, on the image capture device, of the one or more edited images into one or more of the stored images.

11. A method for interconnected image processing, comprising: providing one or more stored images in an image capture device; providing a personal computer, comprising a graphical user interface; providing a data link for connecting the image capture device with the personal computer; and editing the stored images on the image capture device via one or more commands sent from the personal computer via the data link.

12. The method of embodiment 11, wherein the commands are user inputs from a graphical user interface on the personal computer.

13. The method of embodiment 12, wherein the user may issue edit commands to the image capture device to edit one or more of the stored images.

14. The method of embodiment 13, wherein the edit commands are selected from one or more commands of a group of commands consisting of: select, cut, copy, paste, move, delete, and view.

15. A computer and programming executable on the computer for performing the method for interconnected image processing of embodiment 11.

16. A computer program, stored on a computer readable medium, and executable on a computer for performing the method for interconnected image processing of embodiment 11.

17. The method of embodiment 11, comprising: decompressing, on the image capture device, of at least a portion of the stored images; compressing, on the image capture device, of one or more edited images into one or more compressed edited images; and storing, on the image capture device, one or more of the compressed edited images as one or more of the stored images.

18. The method for interconnected image processing of embodiment 17, wherein the decompressing and compressing steps are selected from codecs selected from the group of codecs consisting of: BMP, TIFF, DPCM, LZW, entropic encoding, GIF, PNG, MNG, RAW, JPEG, MPEG-2, MPEG-4, VC1, and H.264.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An interconnected image processing system, comprising:
an image capture device, comprising one or more stored images;
a personal computer, comprising a graphical user interface;
wherein the image capture device and the personal computer are interconnected through a data link; and
means for editing the stored images on the image capture device via one or more commands entered by a user that interacts with the graphical user interface.

2. The system of claim 1, wherein the image capture device is selected from a group of image capture devices consisting of: a digital still camera and a video camera.

3. The system of claim 1, wherein the means for editing comprises:
one or more instructions sent from the personal computer to the image capture device over the data link;
wherein one or more digital edit commands are executed by the image capture device on one or more of the stored images.

4. The system of claim 3, wherein the data link is selected from a group of interconnections consisting of: a Universal Serial Bus (USB) cable, an IEEE 1394 cable, a SATA cable, an eSATA cable, a Bluetooth connection, a fiber optic connection, a wireless 802 connection, and an infrared connection.

5. The system of claim 1, wherein the data link comprises a data bus that interconnects the image capture device to the personal computer, whereby bidirectional data may flow.

6. The system of claim 1, wherein the image capture device comprises an image processing unit.

7. The system of claim 1, wherein the one or more stored images are selected from a group of stored images consisting of: digital still images, a group of pictures (GOP), and a combination of the foregoing.

8. The system of claim 7, wherein the group of pictures (GOP) comprise B pictures, I pictures, P pictures, and combinations of the foregoing pictures.

9. The system of claim 1, wherein the commands comprise one or more commands consisting of: select, cut, copy, paste, move, delete, and view.

10. The system of claim 1, wherein the means for editing comprises:
a decompression, on the image capture device, of at least a portion of the stored images;
a compression, on the image capture device, of one or more edited images; and
an output, on the image capture device, of the one or more edited images into one or more of the stored images.

11. A method for interconnected image processing, comprising:
providing one or more stored images in an image capture device;
providing a personal computer, comprising a graphical user interface;
providing a data link for connecting the image capture device with the personal computer; and
editing the stored images on the image capture device via one or more commands sent from the personal computer via the data link.

12. The method of claim 11, wherein the commands are user inputs from a graphical user interface on the personal computer.

13. The method of claim 12, wherein the user may issue edit commands to the image capture device to edit one or more of the stored images.

14. The method of claim 13, wherein the edit commands are selected from one or more commands of a group of commands consisting of: select, cut, copy, paste, move, delete, and view.

15. A computer and programming executable on said computer for performing the method for interconnected image processing of claim 11.

16. A computer program, stored on a computer readable medium, and executable on a computer for performing the method for interconnected image processing of claim 11.

17. The method of claim 11, comprising:
decompressing, on the image capture device, of at least a portion of the stored images;
compressing, on the image capture device, of one or more edited images into one or more compressed edited images; and
storing, on the image capture device, one or more of the compressed edited images as one or more of the stored images.

18. The method of claim 17, wherein the decompressing and compressing steps are selected from codecs selected from the group of codecs consisting of: BMP, TIFF, DPCM, LZW, entropic encoding, GIF, PNG, MNG, RAW, JPEG, MPEG-2, MPEG-4, VC1, and H.264.
